(19) United States
(12) Patent Application Publication
(10) Pub. No.: US 2022/0151033 A1
(43) Pub. Date: May 12, 2022

(54) FOOD PREPARATION SYSTEM

(71) Applicant: BSH Hausgeräte GmbH, Munich (DE)

(72) Inventors: Carlos Franco Gutierrez, Zaragoza (ES); Teresa Del Carmen Marzo Alvarez, Zaragoza (ES); David Paesa Garcia, Zaragoza (ES); Maria Parra Borderías, Zaragoza (ES)

(21) Appl. No.: 17/438,955

(22) PCT Filed: May 8, 2020
(86) PCT No.: PCT/EP2020/062826

§ 371 Date: Sep. 14, 2021

(30) Foreign Application Priority Data
May 9, 2019 (EP) 19382354.9

(51) Int. Cl. H05B 6/06; H05B 6/64

(52) U.S. Cl. CPC H05B 6/062; H05B 2213/06; H05B 6/6435

(57) ABSTRACT

A food preparation system includes a food treatment unit having a food treatment function, a functional unit having an auxiliary function associated with the food treatment function, and a control unit provided to cause execution of a recipe and to control the food treatment function and the auxiliary function in an open-loop and/or closed-loop manner when guided by the recipe.

The invention relates to a food preparation system as claimed in claim 1 and a method for operating a food preparation system as claimed in claim 15.

A food preparation system comprising a food treatment unit, which is a cooktop, is already known from the prior art. In an operating state a control unit integrated in the cooktop guides through a recipe, by way of an output unit. While guiding through the recipe the control unit controls a food treatment function of the food treatment unit as a function of an operating input by means of an operator interface. While guiding through the recipe the control unit prompts an operator to control an auxiliary function of a functional unit of the food preparation system associated with the food treatment function. An operator controls the auxiliary function manually as a function of a prompt by the control unit.

It is the object of the invention in particular to provide a generic system with improved properties relating to ease of use. According to the invention the object is achieved by the features of claims 1 and 15, while advantageous embodiments and developments of the invention will emerge from the subclaims.

A food preparation system is proposed, in particular with at least one output unit, with at least one food treatment unit, which has at least one food treatment function, with at least one functional unit, which has at least one auxiliary function associated with the food treatment function, and with at least one control unit, which is provided to guide through at least one recipe, in particular to prepare at least one dish and/or at least one food and/or at least one product, in particular by way of the output unit, and which controls the food treatment function and the auxiliary function in an open-loop and/or closed-loop manner while guiding through the recipe.

Such an embodiment in particular allows a high level of ease of use to be achieved. In particular it makes it easier for an operator to be guided through the recipe, in particular compared with a manual performance of the auxiliary function. In particular it allows a high level of reproducibility for preparation results, in particular due to the minimal human intervention required during preparation. In particular an operator is able to perform at least one further function, at least to some degree at the same time as controlling the food treatment function and the auxiliary function in an open-loop and/or closed-loop manner, allowing in particular fast preparation of the recipe and/or multitasking. An operator is able in particular to build up a significant degree of self-confidence, in particular as a result of being guided through recipes that were hitherto unknown and/or appeared too difficult, which said operator can now easily prepare in particular due to the assistance of the control unit. A high level of flexibility in particular is also possible, as guidance can be provided in particular through a plurality of and preferably all imaginable recipes, regardless of the type and/or embodiment of the auxiliary function and/or functional unit.

A “food preparation system” refers in particular to a system, which comprises at least the food treatment unit, the main function of which is in particular the food treatment function, and in particular the preparation of at least one food and/or at least one product, and which in particular comprises at least the functional unit, the main function of which is in particular the auxiliary function associated with the food treatment function.

A “food treatment unit” refers in particular to a unit, which is provided in particular for the thermal and/or mechanical treatment of at least one food and/or at least one product. The product could be in particular the result of mixing and/or combining at least two foods. In particular the food treatment function could comprise at least one function for the thermal and/or mechanical treatment of at least one food and/or at least one product.

A “functional unit” refers in particular to a unit, which is provided in particular to assist with the performance of the food treatment function, in particular by means of the auxiliary function. For example the auxiliary function could comprise at least one function for the thermal and/or mechanical treatment of at least one food and/or at least one product. Alternatively or additionally the auxiliary function could comprise at least one function for outputting at least one information item, for example at least one time and/or at least one warning. The auxiliary function is useful in particular for preparing at least one food and/or at least one product. In particular the auxiliary function could be controlled by means of the functional unit, in particular by machine and advantageously by the control unit. At least one function complementary to the auxiliary function could be provided for example for manual performance by an operator, in particular excluding the functional unit. In particular by controlling the auxiliary function in an open-loop and/or closed-loop manner the control unit takes over the manual performance of the function complementary to the auxiliary function from an operator, thereby resulting in a particularly high level of ease of use.

The functional unit and the food treatment unit are in particular configured differently from one another. In particular the functional unit is a standalone appliance and/or a standalone unit. The food treatment unit is in particular a standalone appliance and/or a standalone unit. In particular the food treatment unit and/or the functional unit could be an, in particular electrical and/or electronic, household appliance.

The expression that the auxiliary function is “associated” with the food treatment function means in particular that the auxiliary function is linked to the food treatment function and in particular that the auxiliary function at least facilitates the performance of the food treatment function. For example it could be possible to perform the food treatment function only after the auxiliary function has been successfully performed. Alternatively or additionally performance of the food treatment function could in particular be a function of performance of the auxiliary function. In particular performance of the auxiliary function could facilitate and/or allow performance of the food treatment function. The auxiliary function could in particular improve a preparation result that can be achieved with the food treatment function and/or increase the probability of achieving a preparation result that can be achieved with the food treatment function, in particular in a reproducible and/or repeated manner.

A “control unit” refers in particular to an electronic unit, which controls at least the food treatment function and/or at least the auxiliary function in an open-loop and/or closed-loop manner in at least one operating state. The control unit in particular comprises at least one computation unit and in particular in addition to the computation unit at least one storage unit, in which in particular at least one open-loop and/or closed-loop control program is stored, which is provided in particular to be run by the computation unit. In particular the control unit is provided to control at least one, in particular electrical and/or electronic, household appliance, which could be identical in particular to the food treatment unit and/or the functional unit, in an open-loop and/or closed-loop manner.

In particular the control unit is provided to control at least one, in particular electrical and/or electronic, household appliance object that is different from the control unit in an open-loop and/or closed-loop manner. A “household appliance object” refers in particular to at least a part, in particular a sub-assembly, of a household appliance, in particular a cooking appliance, advantageously an induction cooking appliance. At least one household appliance object could be for example at least one operator interface and/or at least one heating unit and/or at least one inverter and/or at least one extraction unit and/or at least one household appliance electronics unit.

An “output unit” refers in particular to a unit, which is provided to provide an operator in particular optically and/or acoustically and/or haptically with at least one variable, for example an information item and/or time data and/or an operating prompt and/or an action prompt and/or a selection. The output unit could be provided in particular to output at least one acoustic signal and/or in particular at least one acoustic sequence, for example a ringtone and/or a warning signal and/or a prompt in the form of an in particular preset phrase. Alternatively or additionally the output unit could be provided to supply an optical output, for example a display of at least one image and/or at least one text and/or at least one figure and/or at least one animation. The output unit could for example comprise at least one speaker. Alternatively or additionally the output unit could comprise a display unit, in particular with at least one illuminant, advantageously an LED, and/or an in particular backlit display, in particular a matrix display and/or an LCD display, an OLED display and/or electronic paper. The output unit advantageously comprises at least one liquid crystal display.

The food preparation system in particular has at least one operator interface, which in particular comprises the output unit. The operator interface is provided in particular at least for operating input, in particular by an operator. For example the operator interface could comprise at least one touch operating element. Alternatively or additionally the operator interface could comprise at least one acoustic input element, for example at least one microphone, which could be provided in particular for acoustic input. Alternatively or additionally the operator interface could comprise for example at least one mechanical input element, for example at least one joystick and/or at least one keyboard and/or at least one mouse. In particular the operator interface and the output unit could be embodied at least to some degree as a single piece with one another.

A “recipe” refers in particular to a temporal sequence of heat settings and/or other operating settings and/or action prompts and/or recipe steps for the preparation of at least one food and/or at least one item to be cooked and/or at least one dish and/or at least one product. The heat settings could for example comprise at least one heating period and/or at least one heat output and/or at least one heating temperature and/or at least one heating mode, for example frying and/or boiling and/or steaming and/or simmering and/or defrosting and/or cooking under pressure, in particular in a pressure cooker, and/or deep-frying and/or sautéing and/or poaching and/or baking and/or grilling. The operating settings could comprise for example at least one time period, which defines a total recipe time, and/or at least one temporal sequence of recipe steps and/or at least one type of output by way of the output unit, for example optical and/or acoustic.

The recipe is embodied in particular as a cooking recipe and/or a baking recipe and/or a food preparation recipe. In particular the recipe comprises at least two, in particular at least three, advantageously at least four, particularly advantageously at least five, preferably at least six and particularly preferably multiple recipe steps.

A “recipe step” refers in particular to a sub-segment of a recipe which comprises an in particular defined time period and an in particular defined method step, for example a heating step and/or a step including an interaction by way of the operator interface and/or a step including processing of at least one food and/or a step including preliminary preparation of at least one food, the time period being in particular permanently predefined and/or variable, in particular as a function of a time period required for an operating input by means of the operator interface.

The expression that the control unit is provided “to guide” through at least one recipe means in particular that the control unit is provided to guide through at least one recipe and/or that the control unit guides through at least one recipe in at least one operating state.

The expression that the control unit is provided to “guide” through at least one recipe step of the recipe by way of the output unit means in particular that in at least one operating state, in particular by means of at least one output by way of the output unit, the control unit prompts at least one action and/or outputs at least one information item and/or that in at least one operating state the control unit automatically undertakes and/or initiates recipe steps required to perform the recipe. “Automatic” means in particular independently and/or without interaction by means of the operator interface and/or without action on the part of the operator.

The dish is in particular characterized by at least one ingredient combination, which in particular defines a totality of all the ingredients provided to prepare the dish and/or which is characterized in particular by all the ingredients provided to prepare the dish, in particular in respect of ingredient quantity and/or ingredient quality and/or food type and/or ingredient type. Omission of at least one ingredient and/or a change to at least one ingredient results in particular in a further dish that is different from the dish. In particular the ingredient combination is a totality of all the ingredients provided in particular to be cooked and/or processed and/or prepared together, which are in particular all arranged in at least one and advantageously the same cookware item in at least one operating state.

A temporal “sequence” of the recipe refers in particular to a number of recipe steps following the recipe step temporally and/or a series of recipe steps following the recipe step temporally and/or an ingredient to be added in at least one temporally following recipe step, in particular in respect of ingredient quantity and/or ingredient quality and/or food type and/or ingredient type.

In particular while guiding through the recipe the control unit at least initiates at least one action to perform the food treatment function and the auxiliary function. The expression that while guiding through the recipe the control unit “at least initiates” at least one action to perform the food treatment function and the auxiliary function means in particular that while guiding through the recipe the control unit initiates at least one action to control the food treatment function and the auxiliary function in an open-loop and/or closed-loop manner and/or that while guiding through the recipe the control unit itself controls the food treatment function and the auxiliary function in an open-loop and/or closed-loop manner.

“Provided” means in particular specifically programmed, designed and/or equipped. That an object is provided for a specific function means in particular that the object fulfils and/or performs said specific function in at least one application and/or operating state.

It is further proposed that while controlling the food treatment function and/or the auxiliary function in an open-loop and/or closed-loop manner the control unit automatically sets the operating parameters required to reach a predefined target value. In particular the predefined target value could be at least one preparation result to be achieved in particular with at least one recipe step of the recipe and/or at least one preparation state to be reached in particular in at least one recipe step of the recipe. The operating parameter could comprise in particular at least one speed and/or at least one acceleration and/or at least one heat output and/or at least one heat output density and/or at least one heat output level and/or at least one temperature and/or at least one time interval. In particular the target value is predefined and/or set by at least one recipe step of the recipe and/or by the recipe. This means an operator in particular no longer has to set operating parameters, resulting in a high level of ease of use and/or in, particularly reproducibly, optimal preparation results.

For example while guiding through the recipe the control unit could automatically activate, in particular control the food treatment function and/or the auxiliary function in an open-loop and/or closed-loop manner, in particular further to activation. The control unit is preferably provided to output at least one information item before activation of the food treatment function and/or the auxiliary function. In particular the control unit outputs at least one information item, in particular to an operator, in particular by means of the output unit and/or by means of the operator interface, before activation of the food treatment function and/or the auxiliary function. The control unit could inform an operator in particular, for example by means of the information item, in particular of an in particular imminent and/or upcoming activation of the food treatment function and/or the auxiliary function. Alternatively or additionally the control unit could in particular output at least one operating prompt, in particular to an operator, for example by means of the information item, for example to confirm activation of the food treatment function and/or the auxiliary function. In particular while guiding through the recipe the control unit could output at least one information item relating to a type and/or embodiment of the functional unit, in particular repeating this before each activation of the functional unit. This results in a high level of information and/or transparency for an operator. In particular it ensures a high safety standard.

The control unit could inform an operator in particular, for example by means of the information item, in particular of an in particular imminent and/or upcoming activation of the food treatment function and/or the auxiliary function and activate the food treatment function and/or the auxiliary function automatically in particular after the end of a predefined time interval. The control unit is preferably provided in particular only to activate the food treatment function and/or the auxiliary function as a function of at least one operating input, in particular by means of the operator interface, in particular while guiding through the recipe. The control unit in particular only activates the food treatment function and/or the auxiliary function as a function of at least one operating input, in particular by means of the operating interface, while guiding through the recipe. This ensures a high safety standard and allows predefined safety standards to be met.

For example the food preparation system could comprise just one and/or only one functional unit, in particular just the and/or only the functional unit. The food preparation system preferably comprises at least one further functional unit, which has at least one further auxiliary function, which the control unit controls in an open-loop and/or closed-loop manner while guiding through the recipe.

The auxiliary function and the further auxiliary function could be identical for example. The auxiliary function and the further auxiliary function are in particular different from one another. The further functional unit is in particular a standalone appliance and/or a standalone unit. In particular the functional unit and the further functional unit are configured in particularly differently from one another. This results in particular in greater flexibility. In particular it is possible to prepare a plurality of dishes and/or foods and/or products, as a plurality of options for treating and/or processing can in particular be made available.

It is also proposed that the control unit is provided to guide through at least one further recipe step of the recipe during the performance of the auxiliary function. In particular while guiding through the recipe during the performance of the auxiliary function the control unit guides through at least one further recipe step of the recipe. The expression that the control unit guides through at least one further recipe step of the recipe “during” the performance of the auxiliary function means in particular that the control unit performs the auxiliary function and guides through at least one further recipe step of the recipe at least to some degree simultaneously. This in particular allows optimized time allocation and/or time optimization, resulting in fast preparation and/or performance of the recipe.

For example while guiding through the recipe the control unit could control the food treatment function and the auxiliary function in an open-loop and/or closed-loop manner at least to some degree in different time intervals and/or recipe steps. While guiding through the recipe the control unit preferably controls the food treatment function and the auxiliary function in an open-loop and/or closed-loop manner at least to some degree simultaneously. The expression that the while guiding through the recipe the control unit controls the food treatment function and the auxiliary function in an open-loop and/or closed-loop manner “at least to some degree simultaneously” means in particular that while guiding through the recipe the control unit controls the food treatment function and the auxiliary function in an open-loop and/or closed-loop manner simultaneously in at least one time interval and could control at least one of the functions, in particular the food treatment function and/or the auxiliary function alone, in an open-loop and/or closed-loop manner in at least one further time interval that is different from the time interval. This in particular allows time-optimized guidance through the recipe, allowing an operator in particular to prepare the recipe quickly and leaving said operator in particular sufficient time for other activities.

It is further proposed that the food treatment unit is provided to treat at least one food and/or at least one product thermally by means of the food treatment function. In particular the food treatment unit treats at least one food and/or at least one product thermally by means of the food treatment function in particular in at least one operating state and/or while guiding through the recipe. The food treatment function in particular comprises at least one thermal treatment, in particular of at least one food and/or at least one product. In particular the food treatment function could comprise at least one baking function and/or at least one cooking function. This in particular allows the preparation of hot dishes and/or foods and/or products, resulting in particular in a high level of ease of use and/or a wide range of preparation options.

The food treatment unit could be a cooking appliance for example. The food treatment unit could be a microwave and/or an oven and/or a cooker and/or a grill appliance for example. The food treatment unit is preferably a cooktop and particularly preferably an induction cooktop. This result in a particularly high level of ease of use.

For example the functional unit could treat at least one food and/or at least one product thermally by means of the auxiliary function, in particular in at least one operating state and/or while guiding through the recipe. The functional unit is preferably provided to treat at least one food and/or at least one product mechanically by means of the auxiliary function. In particular the functional unit treats at least one food and/or at least one product mechanically by means of the auxiliary function, in particular in at least one operating state and/or while guiding through the recipe. The auxiliary function in particular comprises at least one mechanical treatment, in particular of at least one food and/or at least one product. In particular the auxiliary function could comprise at least one mixing function and/or at least one stirring function and/or at least one chopping function and/or at least one kneading function. This in particular allows the preparation of foods and/or products in a plurality of different states, as the foods and/or products can be brought to a suitable state in particular by means of the auxiliary function.

It is further proposed that the functional unit and/or in particular the further functional unit is provided to output at least one information item by means of the auxiliary function. In particular the functional unit outputs at least one information item by means of the auxiliary function in particular in at least one operating state and/or while guiding through the recipe. The auxiliary function in particular comprises at least one outputting of at least one information item. The functional unit could be for example a buzzer and/or an output unit. This results in a high level of information and/or transparency for an operator.

It is also proposed that the functional unit and in particular the further functional unit is configured as a small appliance and provided in particular to be transported by an operator. This results in a high level of flexibility, in particular with regard to the positioning of the functional unit and/or the further functional unit. In particular it allows easy storage and/or stowing of the functional unit and/or the further functional unit.

For example the control unit could control the auxiliary function of the functional unit and/or the further auxiliary function of the further functional unit in an open-loop and/or closed-loop manner regardless of the position of the functional unit and/or the further functional unit relative to the food treatment unit. The control unit could use different communication methods in particular for short distances and long distances between the food treatment unit and at least one of the functional units. The control unit is preferably provided to output at least one operating prompt for positioning the functional unit and/or the further functional unit in proximity to the food treatment unit. In particular while guiding through the recipe the control unit outputs at least one operating prompt for positioning the functional unit and/or the further functional unit in proximity to food treatment unit. “Proximity” to an object refers in particular to a spatial range extending from the center point and/or center of gravity of the object over an extension of maximum 500%, in particular maximum 400%, advantageously maximum 300%, particularly advantageously maximum 250%, preferably maximum 200% and particularly preferably maximum 150% of a maximum extension of the object. An “extension” of an object refers in particular to a maximum distance between two points of a perpendicular projection of the object onto a plane. This in particular allows simple control of the functional unit and/or the further functional unit in an open-loop and/or closed-loop manner, as transmission problems in particular are highly unlikely. In particular an operator can prepare the recipe in a small space, resulting in particular in short paths during recipe preparation and/or fast recipe preparation.

For example the control unit could be integrated at least largely in at least one mobile device. The food preparation system could comprise for example at least one mobile device, in particular at least the mobile device. The mobile device could be for example a laptop and/or a tablet and/or a mobile phone. The control unit is preferably integrated at least largely in the food treatment unit. “At least largely” refers in particular to a percentage, in particular a mass percentage and/or a volume percentage and/or a percentage of a number, of at least 70%, in particular at least 80%, advantageously at least 90% and preferably at least 95%. This means in particular that few parts are required and/or little storage capacity and/or the control unit is arranged in a protected manner.

A particularly high level of ease of use can be achieved in particular by a method for operating an inventive preparation system, with which at least one food treatment function of at least one food treatment unit and at least one auxiliary function of at least one functional unit are controlled in an open-loop and/or closed-loop manner while guiding through at least one recipe.

The food preparation system here should not be restricted to the application and embodiment described above. In particular the food preparation system can have a number of individual elements, parts and units that is different from the number cited herein in order to comply with a mode of operation described herein.

Further advantages will emerge from the description of the drawing which follows. The drawing shows exemplary embodiments of the invention. The drawing, description and claims contain numerous features in combination. The person skilled in the art will expediently also consider the features individually and bring them together in useful further combinations.

In the drawing:

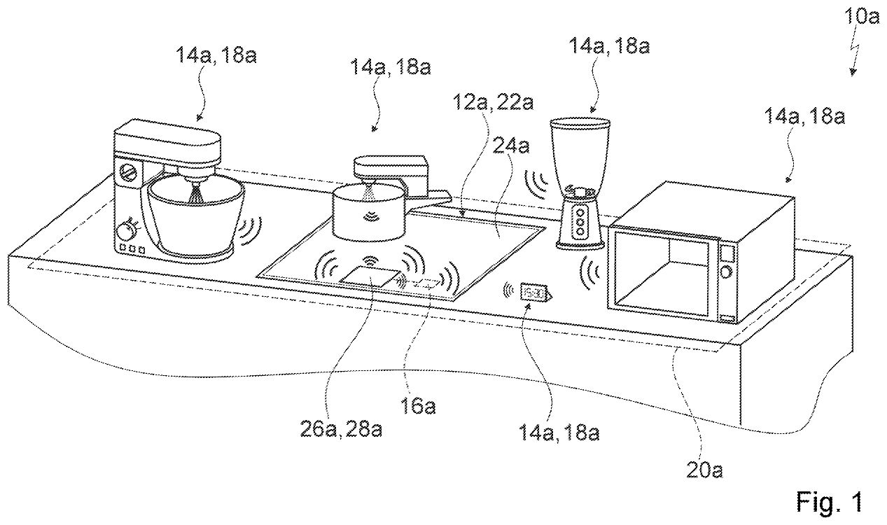

FIG. 1 shows a schematic perspective view of a detail of a food preparation system and

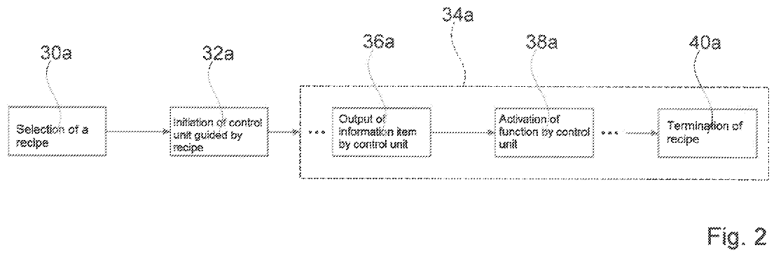

FIG. 2 shows a schematic diagram of a method for operating the food preparation system.

FIG. 1 in particular shows a food preparation system 10a, which in particular comprises at least one and advantageously just one food treatment unit 12a.

In the present exemplary embodiment the food treatment unit 12a in particular has a number of food treatment functions. In particular in a least one operating state the food treatment unit 12a treats at least one food and/or at least one dish and/or at least one product thermally by means of at least one of the food treatment functions. At least one of the food treatment functions could comprise for example sautéing and/or boiling and/or cooking and/or steam cooking and/or simmering and/or poaching and/or grilling and/or baking and/or keeping warm and/or heating and/or blanching and/or frying and/or steaming and/or deep-frying and/or braising and/or stewing. Only one of the food treatment functions is described in the following.

In particular the food treatment unit 12a is a cooking appliance. The food treatment unit 12a could for example be at least one oven, for example a cooker and/or a conventional oven. Alternatively or additionally the food treatment unit 12a could for example be a microwave and/or a grill appliance and/or a steam cooker. In the present exemplary embodiment the food treatment unit 12a is advantageously a cooktop 22a. The food treatment unit 12a is in particular an induction cooking appliance. In particular in the present exemplary embodiment the food treatment unit 12a is an induction cooktop.

The food preparation system 10a in particular has at least one and advantageously just one base body 24a. In the present exemplary embodiment the base body 24a is configured in particular as an appliance plate, in particular as a positioning plate and advantageously as a cooktop plate. In a mounted state the base body 24a in particular forms part of an appliance external housing, in particular a cooktop external housing, in particular an appliance external housing and advantageously a cooktop external housing, in particular of the food treatment unit 12a. The base body 24a is provided in particular for positioning cookware (not shown).

The food preparation system 10a has in particular at least one heating unit (not shown). In the present exemplary embodiment the food preparation system 10a in particular has a plurality of heating units. Only one of the heating units in particular is described in the following. In an installed position the heating unit is arranged in particular below the base body 24a. In a mounted state the heating unit is integrated in particular at least largely and advantageously completely in the food treatment unit 12a, in particular in the cooktop 22a. The heating unit is provided in particular to heat cookware positioned on the base body 24a above the heating unit.

The food preparation system 10a has in particular at least one and advantageously just one operator interface 26a. The operator interface 26a is provided in particular for inputting and/or selecting operating parameters, for example a heat output and/or heat output density and/or heating zone. The operator interface 26a is provided in particular for outputting a value of an operating parameter to an operator. In a mounted state the operator interface 26a is integrated in particular at least largely and advantageously completely in the food treatment unit 12a, in particular in the cooktop 22a. The food treatment unit 12a, in particular the cooktop 22a, in particular comprises the operator interface 26a.

The food preparation system 10a has in particular at least one and advantageously just one output unit 28a. The output unit 28a is configured at least partially as a single piece with the operator interface 26a. In particular the output unit 28a is part of the operator interface 26a. The operator interface 26a in particular comprises the output unit 28a.

The output unit 28a is provided in particular to output, in particular optically, to an operator. In the present exemplary embodiment the output unit 28a comprises in particular a liquid crystal display. Alternatively or additionally the output unit 28a could be provided to output for example optically and/or haptically to an operator.

In a mounted state the output unit 28a is integrated in particular at least largely and advantageously completely in the food treatment unit 12a, in particular in the cooktop 22a. The output unit 28a is in particular part of the food treatment unit 12a, in particular the cooktop 22a. Alternatively the output unit 28a could be integrated for example partially in the food treatment unit 12a and in particular partially in at least one mobile device of the food preparation system 10a. In particular the food treatment unit 12a, in particular the cooktop 22a, comprises the output unit 28a.

The food preparation system 10a in particular has at least one and advantageously just one control unit 16a. The control unit 16a is provided in particular to perform actions and/or to change settings as a function of operating parameters input by means of the operator interface 26a. In at least one heating operating state the control unit 16a in particular regulates an energy supply to the heating unit. In a mounted state the control unit 16a is integrated in particular at least largely and advantageously completely in the food treatment unit 12a, in particular in the cooktop 22a. The food treatment unit 12a, in particular the cooktop 22a, in particular comprises the control unit 16a.

In particular the food preparation system 10a comprises at least one functional unit 14a. For example the food preparation system 10a could comprise just one functional unit 14a. For example the food preparation system 10a could comprise at least two, in particular at least three, advantageously at least four, particularly advantageously at least five, preferably at least six and particularly preferably multiple functional units 14a. Only one of the functional units 14a is described in the following.

The functional unit 14a in particular has at least one auxiliary function associated with the food treatment function. In the present exemplary embodiment the functional unit 14a is provided in particular to treat at least one food and/or at least one product and/or at least one dish mechanically by means of the auxiliary function. In the operating state the functional unit 14a in particular treats at least one food and/or at least one product and/or at least one dish mechanically by means of the auxiliary function.

In particular the food preparation system 10a comprises at least one further functional unit 18a, in particular in addition to the functional unit 14a. The further functional unit 18a in particular has at least one further auxiliary function associated with the food treatment function.

In the present exemplary embodiment the further functional unit 18a is provided in particular to output at least one information item by means of the further auxiliary function. In the operating state the further functional unit 14a outputs at least one information item in particular by means of the further auxiliary function. Alternatively or additionally the functional unit 14a could output at least one information item in particular by means of the auxiliary function in the operating state.

The control unit 16a is provided in particular to guide through at least one recipe, in particular for preparing at least one food and/or at least one product and/or at least one dish, in particular from at least one ingredient combination, in particular by way of the output unit 28a. In particular the ingredient combination defines a totality of all the ingredients provided to prepare the dish. In the operating state the control unit 16a guides through at least one recipe, in particular by way of the output unit 28a. In particular the control unit 16a is provided to guide through at least one recipe.

While guiding through the recipe the control unit 16a controls in particular the food treatment function and the auxiliary function and in particular the further auxiliary function in an open loop and/or closed loop manner. In particular, while controlling the food treatment function and/or the auxiliary function and/or the further auxiliary function in an open loop and/or closed loop manner, the control unit 16a automatically sets the operating parameters required to reach a predefined target value.

In particular while guiding through the recipe the control unit 16a outputs at least one information item, in particular by means of the output unit 28a and/or by means of the operator interface 26a. For example before performing and/or initiating at least one recipe step of the recipe the control unit 16a could output at least one information item, in particular by means of the output unit 28a and/or by means of the operator interface 26a.

In particular before activating the food treatment function and/or the auxiliary function and/or the further auxiliary function the control unit 16a outputs at least one information item, in particular by means of the output unit 28a and/or by means of the operator interface 26a.

In particular while guiding through the recipe the control unit 16a activates the food treatment function and/or the auxiliary function and/or the further auxiliary function, in particular solely, as a function of at least one operating input, in particular by means of the operator interface 26a. This results in particular in a high level of safety for an operator.

For time optimization reasons in particular, while guiding through the recipe, the control unit 16a could guide through at least one further recipe step of the recipe while performing the auxiliary function. While guiding through the recipe the control unit 16a controls in particular the food treatment function and the auxiliary function and in particular the further auxiliary function in an open-loop and/or closed loop manner, at least to some degree simultaneously.

In particular before starting to guide through the recipe the control unit 16a outputs in particular at least one operating prompt, in particular by means of the output unit 28a and/or by means of the operator interface 26a. In particular the control unit 16a outputs at least one operating prompt for positioning the functional unit 14a and/or the further functional unit 18a in proximity 20a to the food treatment unit 12a.

The functional unit 14a is configured in particular as a small appliance. The functional unit 14a is configured in particular as a household small appliance. In particular the further functional unit 18a is configured as a small appliance. The further functional unit 18a is configured in particular as a household small appliance.

For example the functional unit 14a and/or the further functional unit 18a could be configured as a mixer and/or a blender and/or as a stirring appliance and/or as a chopping appliance and/or as a kneading appliance and/or as a food processor and/or as a buzzer and/or as a kitchen clock and/or as a microwave.

The functional unit 14a and/or the further functional unit 18a could be configured in particular as an electrical and/or electronic small kitchen appliance.

In a method for operating the food preparation system 10a, in particular while guiding through the recipe, the food treatment function of the food treatment unit 12a and the auxiliary function of the functional unit 14a and in particular also the further auxiliary function of the further functional unit 18a are controlled in an open-loop and/or closed loop manner, in particular by the control unit 16a.

In particular in at least one selection step 30a an operator selects at least one recipe, in particular from a catalog of recipes, in particular by means of the operator interface 26a. In particular in at least one initiation step 32a the control unit 16a in particular initiates guiding through the recipe, in particular as a function of an operating input, by means of which the operator in particular selects the recipe. The control unit 16a in particular transitions from the initiation step 32a to at least one recipe guidance step 34a, in which the control unit 16a guides in particular through the, in particular selected, recipe.

In particular while guiding through the recipe, in particular in the recipe guidance step 34a, the control unit 16a controls the food treatment function and the auxiliary function and in particular the further auxiliary function in an open-loop and/or closed-loop manner. In at least one output step 36a in particular, before activation of the food treatment function and/or the auxiliary function and/or the further auxiliary function, the control unit 16a outputs at least one information item, in particular to an operator. In particular in at least one activation step 38a, while guiding through the recipe, in particular in the recipe guidance step 34a, the control unit 16a activates in particular the food treatment function and/or the auxiliary function and/or the further auxiliary function, in particular solely, as a function of at least one operating input.

In particular in at least one termination step 40a, the control unit 16a outputs in particular at least one information item relating to termination of the recipe.

Some examples of guidance through different recipes are set out in particular below, in particular describing guidance through the recipe based on different recipes selected by way of example.

For example an operator selects a recipe for preparing a Bolognese sauce. The recipe for preparing a Bolognese sauce could comprise the recipe steps set out by way of example in the table below.

| Number | Recipe step |
|---|---|
| 1 | Peel and chop onions and garlic |
| 2 | Peel and dice carrots |
| 3 | Heat a pan on the cooktop according to instructions and |
| | further to an, in particular acoustic, output, add oil |
| | and vegetables to pan |
| 4 | When the onions are soft and browning, add the ground meat |
| | and increase the heat output of the heating zone heating the |
| | pan according to instructions |
| 5 | Break the ground meat up with a wooden spoon. When the |
| | ground meat is cooked and lightly browned, add red wine to |
| | deglaze |
| 6 | When the red wine has evaporated, add the tomato puree and |
| | cook briefly |
| 7 | Chop the peeled tomatoes. Add the tomatoes, herbs and |
| | seasoning to the pan and reduce the heat output of the heating |
| | zone heating the pan according to instructions |
| 8 | Simmer the sauce for approximately half an hour |

While guiding through the recipe the control unit 16a could control at least one auxiliary function of the functional unit 14a, which could in particular be a blender, in an open-loop and/or closed-loop manner, for example to chop at least one food, in particular onions and/or garlic. Alternatively or additionally the control unit 16a could in particular grind meat and/or puree tomatoes by means of the auxiliary function, in particular by means of at least one functional unit 14a, which could in particular be a blender.

In particular while performing the auxiliary function the control unit 16a could guide through at least one further recipe step of the recipe. For example while performing the auxiliary function, which could in particular be chopping at least one food, in particular onions and/or garlic, the control unit 16a could guide through at least one further recipe step of the recipe, in particular through the second recipe step of the recipe.

In particular while controlling the food treatment function and/or the auxiliary function in an open-loop and/or closed-loop manner to reach a predefined target value, which could be for example a degree of fineness for chopping at least one food, the control unit 16a could set the required operating parameters automatically. The operating parameters could be in particular be a time period for performance of the auxiliary function and/or a speed of movement of cutting elements of the functional unit.

While guiding through the recipe the control unit 16a controls the food treatment function and the auxiliary function and in particular the further auxiliary function in an open-loop and/or closed-loop manner remotely and/or using wireless communication.

For example an operator selects a recipe for preparing a gorgonzola sauce. The recipe for preparing a gorgonzola sauce could for example comprise the recipe steps set out in the table below.

| Number | Recipe step |
|---|---|
| 1 | Heat a pan on the cooktop according to instructions. Further to |
| | an, in particular acoustic, output add butter and cheese to the pan |
| 2 | Pour in the cream and stir occasionally. Note: constant stirring |
| | substantially reduces risk of burning |

While guiding through the recipe the control unit 16a could in particular control the food treatment function and the auxiliary function in an open-loop and/or closed-loop manner at least to some degree simultaneously, in order for example to prevent burning. For example the control unit 16a could treat at least one food and/or at least one product thermally by means of the food treatment function and mechanically in particular at least to some degree simultaneously by means of the auxiliary function.

In the example of the recipe for preparing a gorgonzola sauce in particular the control unit 16a could heat at least one food and/or at least one product by means of the food treatment function and stir it in particular constantly at least to some degree simultaneously in particular by means of the auxiliary function. The control unit 16a could in particular output at least one operating prompt to position the functional unit 14a, which could in particular be a stirring appliance, on the cookware, in particular on the pan.

While guiding through the recipe the control unit 16a could in particular control the functional unit 14a, which could in particular be a stirring appliance, automatically in an open-loop and/or closed-loop manner and in particular allow an operator to perform at least one further activity, for example preparing at least one further food and/or at least one further product, which is to be added in particular at a later time, in particular while the control unit 16a performs the auxiliary function.

### REFERENCE CHARACTERS

10 Food preparation system
12 Food treatment unit
14 Functional unit
16 Control unit
18 Further functional unit
20 Proximity
22 Cooktop
24 Base body
26 Operator interface
28 Output unit
30 Selection step
32 Initiation step
34 Recipe guidance step
36 Output step
38 Activation step
40 Termination step

1-15. (canceled)

16. A food preparation system, comprising:
a food treatment unit having a food treatment function;
a functional unit having an auxiliary function associated with the food treatment function; and
a control unit provided to cause execution of a recipe and to control the food treatment function and the auxiliary function in an open-loop and/or closed-loop manner when guided by the recipe.

17. The food preparation system of claim 16, wherein the control unit automatically sets operating parameters required to reach a predefined target value, when controlling the food treatment function and/or the auxiliary function in the open-loop and/or closed-loop manner.

18. The food preparation system of claim 16, wherein the control unit is provided to output an information item before activating the food treatment function and/or the auxiliary function.

19. The food preparation system of claim 16, wherein the control unit is provided to activate the food treatment function and/or the auxiliary function as a function of an operating input.

20. The food preparation system of claim 16, further comprising a further functional unit having a further auxiliary function, which the control unit controls in an open-loop and/or closed-loop manner when guided by the recipe.

21. The food preparation system of claim 16, wherein the control unit is provided to cause execution of a further recipe step of the recipe while performing the auxiliary function.

22. The food preparation system of claim 16, wherein the control unit controls the food treatment function and the auxiliary function in the open-loop and/or closed-loop manner at least to some degree simultaneously when guided by the recipe.

23. The food preparation system of claim 16, wherein the food treatment unit is provided to treat food thermally via the food treatment function.

24. The food preparation system of claim 16, wherein the food treatment unit is a cooktop.

25. The food preparation system of claim 16, wherein the functional unit is provided to treat food mechanically via the auxiliary function.

26. The food preparation system of claim 16, wherein the functional unit is provided to output an information item via the auxiliary function.

27. The food preparation system of claim 16, wherein the functional unit is configured as a small appliance.

28. The food preparation system of claim 16, wherein the control unit is provided to output an operating prompt for positioning the functional unit in proximity to the food treatment unit.

29. The food preparation system of claim 16, wherein the control unit is integrated at least largely in the food treatment unit.

30. A method for operating a food preparation system, said method comprising controlling a food treatment function of a food treatment unit and an auxiliary function of a functional unit in an open-loop and/or closed-loop manner when guided by a recipe.

31. The method of claim 30, further comprising automatically setting operating parameters required to reach a predefined target value, when controlling the food treatment function and/or the auxiliary function in the open-loop and/or closed-loop manner.

32. The method of claim 30, further comprising outputting an information item before activating the food treatment function and/or the auxiliary function.

33. The method of claim 30, further comprising activating the food treatment function and/or the auxiliary function as a function of an operating input.

34. The method of claim 30, further comprising controlling a further auxiliary function of a further functional unit in an open-loop and/or closed-loop manner when guided by the recipe.

35. The method of claim 30, further comprising executing a further recipe step of the recipe while performing the auxiliary function.

36. The method of claim 30, wherein the food treatment function and the auxiliary function are controlled in the open-loop and/or closed-loop manner at least to some degree simultaneously when guided by the recipe.

37. The method of claim 30, wherein the food treatment unit is provided to treat food thermally via the food treatment function.

38. The method of claim 30, wherein the functional unit is provided to treat food mechanically via the auxiliary function.

39. The method of claim 30, further comprising outputting an information item via the auxiliary function.

40. The method of claim 30, further comprising outputting an operating prompt for positioning the functional unit in proximity to the food treatment unit.
